(19) United States
(12) Patent Application Publication
(10) Pub. No.: US 2026/0279122 A1
(43) Pub. Date: Sep. 17, 2026

(54) METHOD FOR RELEASE FOR USE OF TELEMATICS SERVICES, MOBILE COMMUNICATION DEVICE AND COMMUNICATION SYSTEM FOR PERFORMING THE METHOD

(71) Applicant: MERCEDES-BENZ GROUP AG, Stuttgart (DE)

(72) Inventors: Stefan BOHM, Aichtal (DE); Manuel GERSTER, Biberach an der Riß (DE); Kerstin SCHMID, Nufringen (DE); Dirk HASSERT, Wangen (DE); Edis CERIC, Stuttgart (DE); Frank-Peter PESL, Kandel (DE)

(21) Appl. No.: 19/123,858

(22) PCT Filed: Sep. 14, 2023
(86) PCT No.: PCT/EP2023/075255

§ 371 Date: Apr. 24, 2025

(30) Foreign Application Priority Data
Oct. 25, 2022 (DE) 10 2022 003 988.5

(51) Int. Cl. G07C 9/00; B60R 25/24; H04W 4/30; H04W 12/06; H04W 12/08; H04W 12/30

(52) U.S. Cl. CPC G07C 9/00571; B60R 25/24; H04W 12/06; H04W 12/08; H04W 12/30; H04W 4/30

(57) ABSTRACT

Use of telematics services for a vehicle is released using at least one digital vehicle key and an executable app, which executes a telematics service, stored on a mobile communication device. Execution of the app by the mobile communication device causes a provided vehicle to be selected and authentication of the mobile communication device or the to be performed using the at least one digital vehicle key with a vehicle backend assigned to the vehicle. The vehicle backend determines whether the telematic services are released based on the at least one digital vehicle key.

### BACKGROUND AND SUMMARY OF THE INVENTION

Exemplary embodiments of the invention relate to a method for release for use of telematics services for a vehicle, a mobile communication device for performing the method, and a communication system for performing the method.

Numerous vehicle manufacturers provide so-called telematics services for their vehicles, which provide useful vehicle functions for a user of a corresponding vehicle. For example, navigation services, traffic information services, the opening and closing of windows and doors of the vehicle, remote control assistants and programming a vehicle parking heater, to name only a few. Following their registration and release, the user of the vehicle can use the telematics services in a server infrastructure of the vehicle manufacturer, assigned to the vehicle and referred to as vehicle backend in the following, typically via a mobile communication device using an app provided by the vehicle manufacturer, which directly communicates with the vehicle for realizing the desired vehicle functions. A disadvantage is that registering and releasing the telematics services before they are used involves a certain amount of effort, whereby the comfort experience with the vehicle is diminished for the user.

An apparatus and a method for controlling access authorization and/or drive authorization for a vehicle, in particular using a mobile communication device, is known from DE 10 2012 012 389 A1 .

Exemplary embodiments of the invention are therefore directed to an improved or at least another embodiment of a method for release for use of telematics services for a vehicle.

The fundamental idea of the invention is to realize a release for use of telematics services for a vehicle using a digital vehicle key.

For this purpose, a method for release for use of telematics services for a vehicle is proposed, in the scope of which a mobile communication device, for example a smartphone, is provided with a storage medium, in which at least one digital vehicle key and an executable app for executing telematics services for the vehicle are stored. Expediently, the at least one digital vehicle key has been created, in a preparation step preceding the method, in the storage medium of the mobile communication device and an associated digital certificate, for example a digital certificate conforming to the X.509v3 standard, has been registered in a vehicle backend assigned to the vehicle.

Furthermore, it is provided that the app has commands which, when executed by the mobile communication device, cause, for example, an available vehicle to be selected by a user request and authentication of the mobile communication device and/or the app to be performed using the at least one digital vehicle key with the vehicle backend. The user request can be realized by a screen request on the mobile communication device, which offers a user a selection of available vehicles. The selection of an available vehicle can alternatively take place without user interaction based on computer-based algorithms. Expediently, the mobile communication device and/or the app can be authenticated to the vehicle backend with a private key of the digital vehicle key. More expediently, during the authentication, the vehicle backend uses the certificate stored for the at least one digital vehicle key in the vehicle backend. It is also provided that the vehicle backend provides telematics services for the vehicle. The vehicle backend can be equipped with suitable hardware and software components for this purpose. Furthermore, in the scope of the method, it is provided that the vehicle backend establishes a user session assigned to the selected vehicle for the mobile communication device and/or the app. In the course thereof, a user of the vehicle can use the telematics services provided for the vehicle using the app if authentication with the vehicle backend was successful.

Due to the invention, telematics services can be released for use for the vehicle conveniently using the digital vehicle key and especially relatively quickly. This obviates the need to register the user in the vehicle backend, as was previously necessary for usage of the telematics service, to subsequently release the telematics services by the vehicle backend, and to perform necessary password-based authentication of the user immediately before using the telematics services. This provides a significant increase in user comfort.

In the invention, telematics services for a vehicle are expediently understood to mean vehicle functions provided by a vehicle backend for a vehicle, which can be performed by the vehicle and can be useful for a user of a corresponding vehicle. For example, telematics services are navigation services, traffic information services, the opening and closing of windows and doors of the vehicle, remote control assistants, and programming a parking heater vehicle. The user of the vehicle can use the telematics services typically using an app provided by the vehicle manufacturer, which, for example, is installed on a mobile communication device, in particular a smartphone, and communicates with the vehicle in order to realize vehicle functions selected by the user in the vehicle. It is understood that corresponding vehicle functions have to be implemented in the vehicle. The user of the vehicle can similarly subsequently release new functions directly via the backend via this communication method (app)—e.g., additional navigation maps, seat heating in the rental model, etc. In particular this is of interest in rental processes.

The mobile communication device can be realized in particular as a smartphone or smartwatch and can be expediently set up to communicate by means of telecommunication with a vehicle backend, at least one vehicle, and at least one further mobile communication device. The invention is however not restricted to mobile communication devices of such type.

In the invention, a digital vehicle key is expediently understood to mean a digital key stored in a storage medium, which in particular enables basic vehicle functions, such as contactless unlocking and locking of the vehicle and starting the vehicle. Along with these basic functions, the at least one digital vehicle key can also provide convenience functions in particular. These include, for example, digitally sharing the digital vehicle key with co-users of the vehicle.

In the invention, an app is expediently understood to mean an executable computer program. This computer program can be optimized for use in a mobile communication device, in particular a smartphone.

In the invention, a vehicle backend is expediently understood to mean any server infrastructure suitable for providing telematics services for vehicles. The vehicle backend can, in particular, comprise backend devices and backend software, i.e., both hardware and software components.

In order to be able to set the extent to which a user is able to use the provided telematics services in the course of the established user session, it can be expedient when the at least one digital vehicle key is provided with right of use features related to telematics services. The extent of the telematics services for the vehicle that can be used in the course of the established user session can, for example, be restricted using the right of use features, so that in particular fewer vehicle functions for the vehicle can be used. The right of use features can, for example, be depicted or implemented on access profiles of the at least one digital vehicle key. This means that the extent of the permitted use of telematics services can be set relatively simply.

In this case, it is expedient when the right of use features assigned to the at least one digital vehicle key are specified by the user of the vehicle, an owner of the vehicle, or a person authorized by the owner of the vehicle or the vehicle backend before the user session is established. Therefore, the extent of use of telematics services in a user session can be specified relatively simply by the user of the vehicle, an owner of the vehicle, or a person authorized by the owner of the vehicle. Use of telematics services for the vehicle is therefore only possible to an extent specified by the right of use features of the digital vehicle key. Expediently, the owner of the vehicle or a person authorized by the owner of the vehicle has full right of use features, so that the use of telematics services of the vehicle is possible to an unrestricted extent. It can be advantageous in a rental situation or when digitally sharing the digital vehicle key with co-users of the vehicle, if the use of the telematics services is configured, for example restricted, before a user session.

Furthermore, it is expedient if the method is performed with a digital friend vehicle key, which, for example, is issued to a co-user of the vehicle by the user of the vehicle, an owner of the vehicle, or a person authorized by the owner of the vehicle using the digital vehicle key. The digital friend vehicle key is expediently generated during digital sharing of the at least one digital vehicle key with a co-user of the vehicle together with an associated certificate, for example the X.509v3 certificate, so that subsequently the digital friend vehicle key is stored in the mobile communication device of the co-user and/or in a storage medium thereof and the associated certificate is registered in a vehicle backend assigned to the vehicle. In the scope of the proposed method, the digital friend vehicle key can be used instead of the digital vehicle key, in order to achieve authentication with the vehicle backend. Thus, it is ensured that a co-user of the vehicle, to whom the user of the vehicle, the owner of the vehicle, or a person authorized by the owner of the vehicle has provided a digital friend vehicle key by digital sharing, can similarly use the telematics services for the vehicle. Therefore, the co-user does not have to transmit any personal data to the vehicle backend, as authentication of the mobile communication device and/or the app of the co-user is realized using the digital friend vehicle key, which is relatively convenient for the co-user.

Expediently, the digital friend vehicle key is similarly equipped with right of use features. This can be configured when issuing the digital friend vehicle key or in a user account of the user created in the vehicle backend, so that when establishing the user session for a co-user of the vehicle, the extent to which the co-user is allowed to use the telematics services for the vehicle in the course of the established user session is set. The right of use features for the friend vehicle key can be specified, for example, by the user of the vehicle or an owner of the vehicle or a person authorized by the owner of the vehicle.

Expediently, it can be provided that the user of the vehicle or an owner of the vehicle or a person authorized by the owner of the vehicle declares the digital friend vehicle key issued to a co-user to be invalid, or the same has become invalid due to expiry of a time period, for example, wherein simultaneously an established user session is ended and cannot be accepted any more. Therefore, it is ensured that after the issuance has ended or the digital friend vehicle key has expired, the rights of use granted to a co-user to the telematics services for the vehicle end and therefore cannot be used any more. Therefore, the method becomes more secure when digitally sharing the digital vehicle key.

Furthermore, it is expedient when, to perform the method, the user of the vehicle or a co-user of the vehicle in particular performs the following steps using the app:
1) starting the app on the mobile communication device;
2) in case at least one digital vehicle key is stored in a storage medium of the mobile communication device, a user request is performed, during which the user decides by selection whether
   a) authentication is to be carried out using the stored at least one digital vehicle key, or
   b) authentication is to be carried out via password-based authentication;
3) alternatively to step 2), the app can decide without user interaction and based on specified computer-based algorithms, for example that authentication is not available via the digital vehicle key, whether
   a) authentication is to be carried out using the stored at least one digital vehicle key, or
   b) authentication is to be carried out via password-based authentication;
4) wherein if a) is selected, the method continues with the following step 6);
5) wherein if b) is selected, a password-based authentication with the vehicle backend is carried out to release telematics services for the vehicle for use;
6) if more than one digital vehicle key is stored in the storage medium of the mobile communication device, a further user request is performed, during which the user decides by selection for which vehicle telematics services are to be used.
   Therefore, a user or co-user of the vehicle can conveniently decide in favor of authentication with the vehicle backend using the digital vehicle key and then, in the case that more than one digital vehicle key is stored in the storage medium of the mobile communication device, can select for which vehicle telematics services are to be used. Therefore, the proposed method is relatively simple to control, which in particular improves customer acceptance.

In particular, it can be provided that the at least one digital vehicle key is provided according to the digital vehicle key standard from the Car Connectivity Consortium. Expediently, the mentioned digital friend vehicle keys are also provided according to the ccc standard. In the present case, the “ccc standard” is expediently specified by the document “Car connectivity consortium digital key release 3 technical specification version 1.0.0(CCC-TS-101)” and successor documents, abbr. CCC, the disclosure of which is included herein by reference in its entirety. Consequently, the at least one digital vehicle key is created, in particular, during a user-pairing or a friend-pairing method of a ccc-compliant mobile communication device in a secure storage element, referred to as secure element, and the digital certificate, in particular the X.509v3 certificate, corresponding to the digital vehicle key is simultaneously registered in the vehicle backend of a selected vehicle. More expediently, the at least one digital vehicle key has an asymmetrical, cryptographic key pair, the so-called public key and private key, and a corresponding certificate, for example the X.509v3 certificate.

It is also expedient if the established user session is carried out as anonymous or pseudonymous, i.e., as an anonymous or pseudonymous user session.

Definition of the data protection authorities for pseudonym:
“The EU's personal data protection legislation defines pseudonymization as the processing of personal data in such a way that this data can no longer be attributed to a specific individual, without the use of additional information.”

Source:
https://edps.europa.eu/press-publications/press-news/blog/pseudonymous-data-processing-personal-data-while-mitigating_en.

The difference between anonymous and pseudonymous is that pseudonyms require additional information in order to draw conclusions about a person. This is no longer possible in the case of anonymous data. This can primarily satisfy a user's data protection interests, as in particular a user does not have to disclose any personal data in order to use telematics services. Furthermore, in particular, a co-user does not have to provide any personal data to the vehicle backend, which is an advantage in a rental situation or when digitally sharing the digital vehicle key for the co-user.

Furthermore, it is conceivable that the method according to the invention serves as an entrance point for new customers of the vehicle backend. This can be achieved by enabling co-users not registered in the vehicle backend, who represent potential new customers for the vehicle backend, to use the telematics services for the vehicle conveniently and relatively quickly using the proposed method, wherein the telematics services are supplemented by programs that enable simple registration of the co-users in the vehicle backend.

According to a further fundamental idea of the invention, a mobile communication device, in particular a smartphone or a smartwatch, is provided which has a computer-readable storage medium, in which at least one digital vehicle key and an executable app for executing telematics services for the vehicle are stored. The mobile communication device is expediently set up to perform the method according to the preceding description. This means that an advantageous mobile communication device is specified, using which the present method can be performed. The mobile communication device is in particular set up so that more than one digital vehicle key can be stored in the computer-readable storage medium.

According to a further fundamental idea of the invention, a communication system for performing the present method according to the preceding description is provided. It has a vehicle set up to perform telematics services, a mobile communication device having a storage medium, designed according to the preceding description and suitable for performing the method according to the preceding description, an executable app, stored in the storage medium of the mobile communication device, for performing telematics services for the vehicle, and a vehicle backend. The app has commands which, when executed by the mobile communication device, cause authentication of the mobile communication device and/or the app to be performed using the at least one digital vehicle key in the vehicle backend assigned to the vehicle. The vehicle backend provides telematics services for the vehicle and is also set up to establish and end at least one user session for a mobile communication device and/or an app, wherein in the course of a user session a respective user of the vehicle can use the telematics services provided for the vehicle using the respective app. This means that an advantageous communication system is specified, using which the present method can be performed.

Furthermore, it can be expedient when the mentioned app uses the digital key framework defined by the CCC during authentication. In the present case, the device-side framework for the digital vehicle key is expediently referred to as a digital key framework, which for example realizes the main functions, such as the vehicle-pairing, digital sharing of digital vehicle keys and management of the digital vehicle key.

Furthermore, if a digital vehicle key or a digital vehicle key provided according to the ccc standard is not available, it is expedient if a vehicle backend or vehicle manufacturer-based parallel process is set up for the digital vehicle key. This can use an asymmetrical, cryptographic key pair consisting of public key and private key together with a certificate, in particular the X.509v3 certificate, like the digital vehicle key provided according to the ccc standard.

It is expedient when the user of the vehicle is the owner of the vehicle, a person authorized by the owner of the vehicle, or the vehicle backend. In a rental situation, the co-user can be a renter of the vehicle or otherwise a person trusted by the user.

To summarize, it should be noted: The invention expediently relates to a method for release for use of telematics services for a vehicle using one digital vehicle key. In particular, the invention relates to a mobile communication device and to a communication system for performing the method.

Further important features and advantages of the invention result from the dependent claims, the drawings and the associated figure description according to the drawings.

It is understood that the aforementioned features and the features to be explained in the following can not only be used in the respectively specified combination, but also in other combinations or in isolation, without leaving the scope of the present invention.

Preferred embodiments of the invention are represented in the drawings and are explained in more detail in the following description, wherein the same reference signs refer to identical or similar or functionally identical components.

### BRIEF DESCRIPTION OF THE DRAWING FIGURES

In the figures:

FIG. 1 shows a very simplified flow chart of the method according to the invention and

FIG. 2 shows a less simplified flow chart of the method according to the invention.

### DETAILED DESCRIPTION

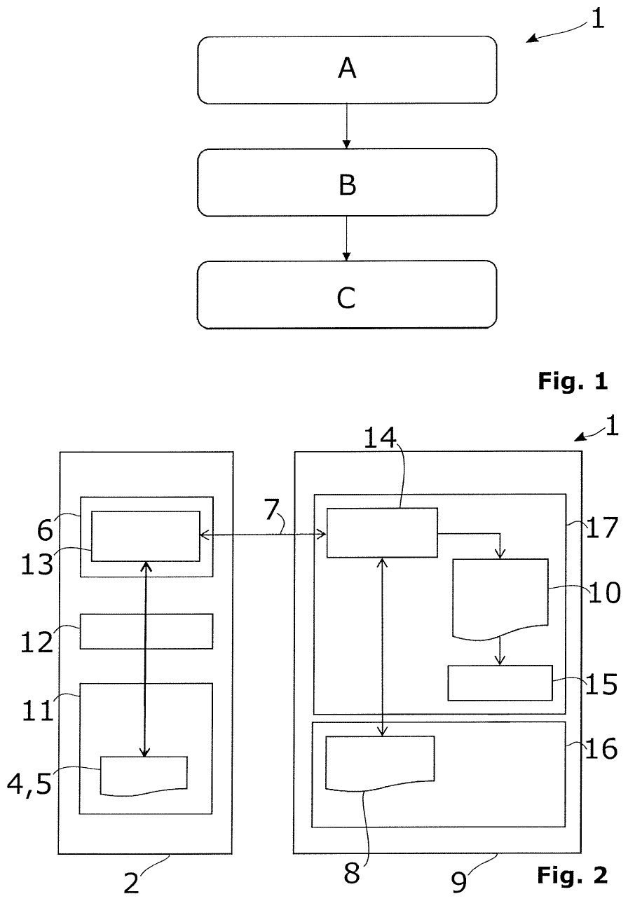

In FIG. 1, a very simplified flow chart of the proposed method 1 for release for use of telematics services for a vehicle is represented, in which, in a first step A, firstly a mobile communication device 2 is provided with a storage medium in which at least one digital vehicle key 4 and an executable app 6 for executing telematics services for a vehicle are stored. Furthermore, it is provided that the app 6 has commands which, when executed by the mobile communication device 2 in a second step B of the method 1, cause a provided vehicle to be selected and authentication of the mobile communication device 2 and/or the app 6 to be performed using the at least one digital vehicle key 4 with a vehicle backend 9 assigned to the vehicle. The mentioned vehicle backend 9 provides telematics services for the vehicle and, in a third step C of the method, establishes a user session 10 assigned to the selected vehicle for the mobile communication device 2 and/or the app 6. Assuming the authentication was successful, in the course of the user session 10, a user of the vehicle can then use the telematics services provided for the vehicle using the mentioned app 6.

In FIG. 2, a flow chart of the proposed method 1, simplified to a lesser extent, for release for use of telematics services for a vehicle is represented, wherein in the scope of the method 1, however, substantially the same method steps A, B and C are performed as in the flow chart illustrated in FIG. 1. Consequently, in FIG. 2, a ccc-compliant, mobile communication device 2 (indicated with a border) is set up to perform the proposed method 1 and for this purpose has a mobile communication device 2 with a storage medium, in which at least one digital vehicle key 4, provided according to the ccc standard, and an executable app 6 for executing telematics services for a vehicle are stored. The app 6, which serves the user as a user interface for using telematics services, comprises or communicates with a security element 11 (secure element) stored in the storage medium and in which the at least one digital vehicle key 4 is located, and uses a digital key framework 12 which is defined according to the ccc standard, is likewise stored in the storage medium and which in the present case offers the device-side framework for working with the at least one digital vehicle key 4.

Purely by way of example, the app 6 has user authentication logic 13, which represents the app-side implementation of the authentication based on the digital vehicle key 4, so to speak. Furthermore, the app 6 comprises commands which, when executed by the mobile communication device 2, cause a provided vehicle to be selected and authentication 7 of the mobile communication device 2 and/or the app 6 to be performed using the private key of the at least one digital vehicle key 4 with a vehicle backend 9 assigned to the vehicle. For this purpose, in the vehicle backend 9 in a preparation step preceding the method 1, a certificate 8 associated with the at least one digital vehicle key 4, for example the X.509v3 certificate, is registered in a digital key backend 16 of the vehicle backend 9.

The mentioned vehicle backend 9, which provides the telematics services for the vehicle, has, purely by way of example, backend authentication logic 14 implemented in a backend app 17 that realizes a server-side implementation of the telematics services and which represents the backend-side implementation of the authentication based on the at least one digital vehicle key 4. In the scope of the proposed method 1, it is provided that the backend authentication logic 14 of the vehicle backend 9 establishes a, for example, anonymous user session 10 assigned to the selected vehicle for the mobile communication device 2 and/or the app 6 if authentication was successful.

In the course of the established user session 10, it is possible for the user of the vehicle to use the telematics services provided for the vehicle using the app 6. It should also be mentioned that the at least one digital vehicle key 4 used for authentication can be provided with right of use features 15 related to telematics services, based on which, when the mentioned user session 10 is being established, the extent to which the telematics services for the vehicle can be used in the course of the user session 10 by the user of the vehicle may be set. For example, in renting situations in which a digital friend vehicle key 5 with a corresponding certificate 8 is issued to a co-user of the vehicle by digitally sharing the at least one digital vehicle key 4, the right of use features 15 are preferably specified by the user of the vehicle, who, for example, is an owner of the vehicle or a person authorized by the owner of the vehicle, before the user session 10 is established.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

1-11. (canceled)

12. A method for release for use of telematics services for a vehicle, the method comprising:
providing a mobile communication device with a storage medium, wherein at least one digital vehicle key and an executable app for executing telematics services for a vehicle are stored in the storage medium;
executing, by the executable app, commands causing
selection of a provided vehicle, and
authentication of the mobile communication device or the app to be performed using the at least one digital vehicle key with a vehicle backend assigned to the vehicle; and
establishing, by the vehicle backend responsive to the authentication being successful, a user session assigned to the selected vehicle for the mobile communication device or the app; and
using, by a user of the mobile communication device or the app and during the established user session, the telematics services provided for the vehicle,
wherein the vehicle backend provides telematics services for the vehicles assigned to the vehicle backend.

13. The method of claim 12, wherein the at least one digital vehicle key includes right of use features related to the telematics services, wherein, based on the right of use features and when the user session is being established, an extent to which the telematics services can be used during the established user session for the user of the vehicle is set.

14. The method of claim 13, further comprising:
specifying, by the user of the vehicle, an owner of the vehicle, a person authorized by the owner of the vehicle, or the vehicle backend before the user session is established, the right of use features.

15. The method of claim 13, further comprising:
issuing, to a co-user of the vehicle using the digital vehicle key, a digital friend key, which is used to authenticate the mobile communication device or the app.

16. The method of claim 15, wherein the digital friend key includes the right of use features.

17. The method of claim 15, further comprising:
declaring, by the user of the vehicle, an owner of the vehicle, or a person authorized by the owner of the vehicle, the digital friend key issued to the co-user of the vehicle to be invalid; and
ending the established user session responsive to the declaring, wherein future user sessions cannot be established anymore with the digital friend key.

18. The method of claim 12, wherein to perform the method, the user of the vehicle or a co-user, using the app, of the vehicle:
1) starts the app on the mobile communication device;
2) in case at least one digital vehicle key is stored in the storage medium of the mobile communication device, performing a user request, during which the user actively decides by selection whether
a) authentication is to be performed using the stored at least one digital vehicle key, or
b) authentication is to be performed via password-based authentication;
3) alternatively to step 2), the app decides without user interaction and based on specified computer-based algorithms whether
a) authentication is to be carried out using the stored at least one digital vehicle key, or
b) authentication is to be carried out via password-based authentication;
4) wherein if 2) a) or 3) a) is performed, the method continues with step 6);
5) wherein if 2) b) or 3)b) is performed, a password-based authentication with the vehicle backend is performed to release telematics services for the vehicle for use;
6) if more than one digital vehicle key is stored in the storage medium of the mobile communication device, a further user request is performed, wherein during the further user request the user actively decides by selection for which vehicle telematics services are to be used.

19. The method of claim 12, wherein the at least one digital vehicle key is provided according to Car Connectivity Consortium Digital Key standard.

20. The method of claim 12, wherein the established user session is performed as an anonymous or pseudonymous user session.

21. A mobile communication device comprising:
a computer-readable storage medium storing at least one digital vehicle key and an executable app configured to execute telematics services for a vehicle,
wherein the mobile communication device is configured to, by executing commands of the executable app,
select a provided vehicle, and
authenticate the mobile communication device or the app to using the at least one digital vehicle key with a vehicle backend assigned to the vehicle, wherein the vehicle backend establishes a user session responsive to the authentication being successful, wherein the established user session is assigned to the selected vehicle for the mobile communication device or the app; and
use, during the established user session, the telematics services provided for the vehicle,
wherein the vehicle backend provides telematics services for vehicles assigned to the vehicle backend.

22. A communication system comprising:
a vehicle configured to execute telematics services;
a mobile communication device comprising a storage medium storing at least one digital vehicle key;
an executable app stored in the storage medium of the mobile communication device, wherein the executable app is configured to execute telematics services for the vehicle, wherein the app has commands which, when executed by the mobile communication device, cause authentication of the mobile communication device or the app to be performed with a vehicle backend assigned to the vehicle using the at least one digital vehicle key; and
a vehicle backend providing telematics services for the vehicle and configured to establish and end a user session assigned to the selected vehicle for the mobile communication device or the app, wherein during the established user session a user of the vehicle can use the telematics services provided for the vehicle using the app.
